(19) United States
(12) Patent Application Publication
(10) Pub. No.: US 2012/0251702 A1
(43) Pub. Date: Oct. 4, 2012

(54) METHOD OF MANUFACTURING PEDIATRIC MEDICINE DOSAGE CUP

(76) Inventors: Jill MALKIN, New Hyde Park, NY (US); Geoffrey J. Addeo, New Hyde Park, NY (US)

(21) Appl. No.: 13/433,575

(22) Filed: Mar. 29, 2012

Related U.S. Application Data
(60) Provisional application No. 61/469,636, filed on Mar. 30, 2011.

(51) Int. Cl. A23L 1/221

(52) U.S. Cl. 426/650

(57) ABSTRACT

A method of manufacturing a dosage cup, comprising the steps of: creating a flavored layer mixture; sterilizing the dosage cup by at least one ozone sterilization device; coating the rim of the dosage cup with the flavored layer mixture to form a flavored layer disposed thereon; and coating the flavored layer with sugar crystals. The ozone sterilization device emits a high-voltage charge to the rim of the cup at an angle in the range of about 0.5 degrees to about 45 degrees. The method may include placing the cup on a conveyor to facilitate the movement of the cup through the high-voltage discharges of the ozone sterilization devices.

### CROSS-REFERENCE TO RELATED APPLICATION

This application is a Section 111(a) application relating to and claims the benefit of commonly owned, co-pending U.S. Provisional Application Ser. No. 61/469,636 entitled “MANUFACTURING PROCESS FOR PEDIATRIC MEDICINE DOSAGE CUP, TRAY, AND FABRICATION METHOD”, filed Mar. 30, 2011, the entirety of which is incorporated herein by reference.

### FIELD OF THE INVENTION

The present invention relates to a method of manufacturing a pediatric medicine dosage cup.

### BACKGROUND OF THE INVENTION

Getting a child to take oral medications can be difficult, since many oral medications have undesirable flavor components. Medicine dosage cups may include candy coatings and other coatings disposed about the rim in effort to negate the undesirable tastes of the medications. Manufacturing such cups must be efficient and sanitary.

### SUMMARY OF THE INVENTION

In an embodiment, a method of manufacturing a dosage cup, comprising the steps of: creating a flavored layer mixture; sterilizing the dosage cup by at least one ozone sterilization device; coating the rim of the dosage cup with the flavored layer mixture to form a flavored layer disposed thereon; and coating the flavored layer with sugar crystals. In an embodiment, the at least one ozone sterilization device emits a high-voltage charge to the rim of the cup at an angle in the range of about 0.5 degrees to about 45 degrees. In an embodiment, the at least one ozone sterilization device includes a pair of ozone sterilization devices. In an embodiment, one of the pair of ozone sterilization devices emits a high-voltage charge that covers one-half of the circumference of the rim of the cup, and the other of the pair of ozone sterilization devices emits a high-voltage charge that covers the other half of the circumference of the rim of the cup.

In an embodiment, the step of coating the rim of the dosage cup with the flavored layer mixture includes dipping the rim of the dosage cup into the flavored layer mixture. In an embodiment, the step of coating the flavored layer disposed on the rim of the dosage cup with sugar crystals includes dipping the rim of the dosage cup into the sugar crystals. In an embodiment, the method further includes the step of placing the cup on a conveyor to facilitate the movement of the cup through the high-voltage discharges of the ozone sterilization devices.

In an embodiment, the flavored layer mixture includes sucrose and at least one natural flavor. In an embodiment, the cup is adapted to measure liquid pediatric medicine.

In an embodiment, the method includes the step of stacking the coated cups within a box insert for packaging.

### BRIEF DESCRIPTION OF THE DRAWINGS

FIG. 1 is a perspective view of a dosage cup constructed in accordance with an embodiment; and

FIG. 2 is an enlarged, partial cross-sectional view of the dosage cup shown in FIG. 1;

FIG. 3 is a flow chart of a method of manufacturing the medicine dosage cup illustrated in FIGS. 1 and 2; and

FIG. 4 is a photograph of the dosage cup being treated by ozone sterilization devices in accordance with an embodiment.

### DETAILED DESCRIPTION OF THE DRAWINGS

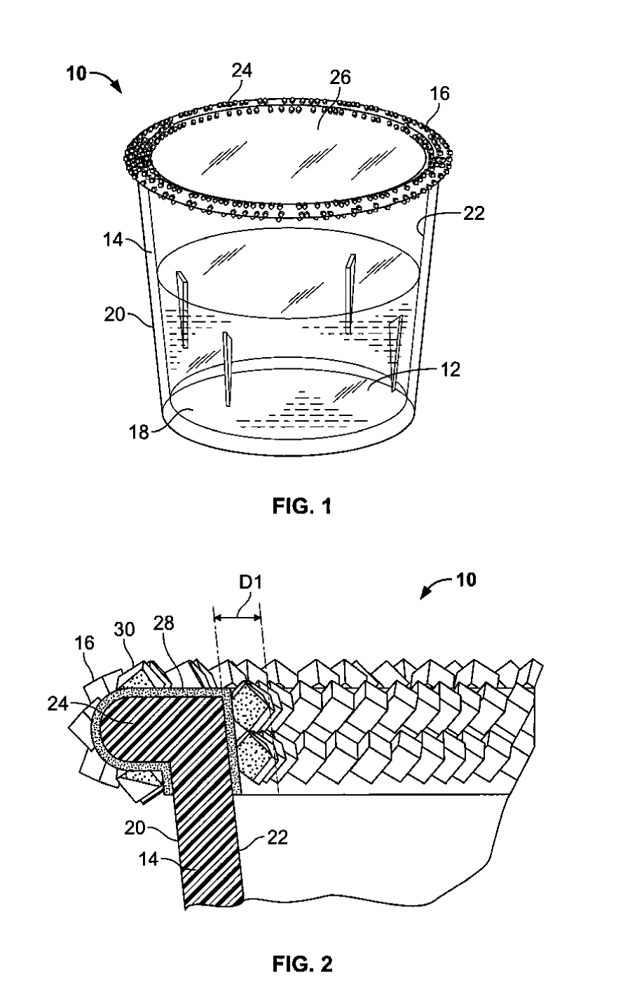

FIG. 1 illustrates an embodiment of a cup 10 for dispensing a liquid medication 12 to a user. In an embodiment, the cup 10 may be configured as a pediatric medicine dosage cup for dispensing a liquid pediatric medication to a child. In an embodiment, the liquid pediatric medication may include any mediation having an undesirable flavor component, such as an analgesic, antihistamine, or diuretic having an unpleasant taste. In an embodiment, the undesirable flavor component may be a bitter flavor. In an embodiment, the cup 10 may be used by adults. In an embodiment, the cup 10 may be used to dispense liquids other than pediatric medications. For example, in other embodiments, the liquid 12 may be a beverage, such as an alcoholic beverage (e.g., a mixed drink or cocktail), juice, milk, water, soda, and the like. In an embodiment, the cup 10 includes a cup portion 14 and a candy coating 16.

In an embodiment, the cup 10 may have the structure and function as the cups disclosed in U.S. Patent Application Publication No. 2009/0287144 to Malkin et al., published on Nov. 19, 2009, entitled “Pediatric Medicine Dosage Cup, Tray and Fabrication Method,” and U.S. Patent Application Publication No. 200810197047 to Malkin et al., published on Aug. 21, 2008, entitled “Pediatric Medicine Dosage Cup, Tray and Fabrication Method” (the “Malkin Applications”), both of which are incorporated by reference herein in their entireties. In an embodiment, the cup portion 14 has a bottom portion 18, and a sidewall 20 with an interior surface 22 and a rim portion 24. In an embodiment, the sidewall 20 extends upwardly from the bottom portion 18. In an embodiment, the interior surface 22 of the sidewall 20 and the bottom portion 18 define an interior portion 26 configured to retain the liquid 12. In an embodiment, the cup portion 14 may be constructed using any suitable cup known in the art. For example, in an embodiment, the cup portion 14 may be formed from an opaque plastic, transparent plastic, or a translucent plastic using any conventional cup forming process. In an embodiment, the cup portion 14 may be constructed from any conventional medical dosage cup known in the art. In an embodiment, the cup portion 14 may be sized to hold three teaspoons of the liquid 12, which may correspond to a three teaspoon dosage of a pediatric medication. In other embodiments, other cup sizes may also be utilized. In an embodiment, the cup portion 14 may have calibrated measurement markings (not shown) satisfying FDA dosing standards.

Turning to FIG. 2, in an embodiment, the candy coating 16 is formed on the rim portion 24 of the cup portion 14. In an embodiment, when the cup 10 is used to dispense pediatric medications, the candy coating 16 masks the taste of the liquid medicine 12 making it more palatable for the user. In an embodiment, the candy coating 16 is made of sugar, natural colors, an acid component, and natural flavors. In an embodiment, an acid component imparts the sour flavor in the candy coating 16. In another embodiment, the candy coating 16 may include agar. In other embodiments, artificial colors instead of or in addition to the natural colors may be included in the candy coating 16. In another embodiment, artificial flavors may be included in the candy coating 16 instead of or in addition to the natural flavors.

In an embodiment, the candy coating 16 extends a distance “D1” into the interior portion 26 of the cup portion 14 from the interior surface 22 of the sidewall 20. In an embodiment, the candy coating 16 has two layers: a flavored layer 28 and a crystal layer 30. In an embodiment, the flavored layer 28 is applied as a liquid and allowed to harden onto the rim portion 24 of the cup portion 14. In an embodiment, the flavored layer 28 includes sugar (e.g., sucrose) and flavoring. In an other embodiment, the flavored layer 28 includes sugar, an acid component, and flavoring. In another embodiment, the flavored layer 28 may include agar.

In an embodiment, the crystal layer 30 includes sugar crystals. In an embodiment, the sugar crystals are colored with one or more colorings. In another embodiment, the crystal layer 30 includes acid crystals (e.g., citric acid crystals). In an embodiment, the crystal layer 30 may include about 5% to about 10% acid crystals and about 90% to about 95% sugar crystals. By way of another embodiment, the crystal layer 30 may include about 6% to about 7% acid crystals and about 93% to about 94% sugar crystals. In an embodiment, the sugar and/or acid crystals may include one or more flavorings.

In an embodiment, the sugar crystals and optional acid crystals are applied to the flavored layer 28 before the flavored layer is completely solid, which will be discussed in further detail hereinafter. In an embodiment, the sugar crystals and optional acid crystals stick to the liquid or semi-liquid flavored layer 28 thereby forming the crystal layer 30, which is loosely adhered to the rim portion 24 when the flavored layer 28 hardens or crystallizes.

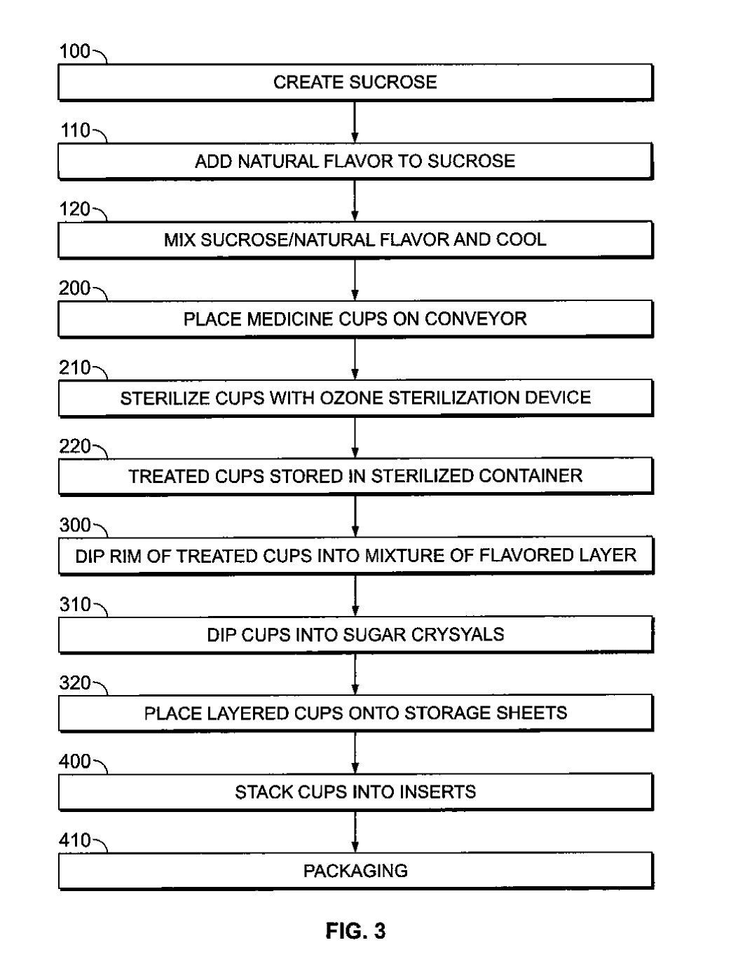

Referring to FIG. 3, in an embodiment, a method of manufacturing the cup 10 includes the phase of creating a mixture of the flavored layer 28. In an embodiment, the flavored layer 28 includes 67.5 Brix sucrose. In an embodiment, the method includes the step 100 of creating the sucrose and the step 110 of adding natural flavor to the sucrose as it cools. In an embodiment, the mixture of the flavored layer 28 includes 2.5% by weight of natural flavor. In an embodiment, the natural flavor may be any fruit flavor, such as blueberry, apple, watermelon, or cherry. In an embodiment, step 120 includes mixing the mixture of the flavored layer 28 (e.g., sucrose and natural flavor) and allowing it to cool to room temperature.

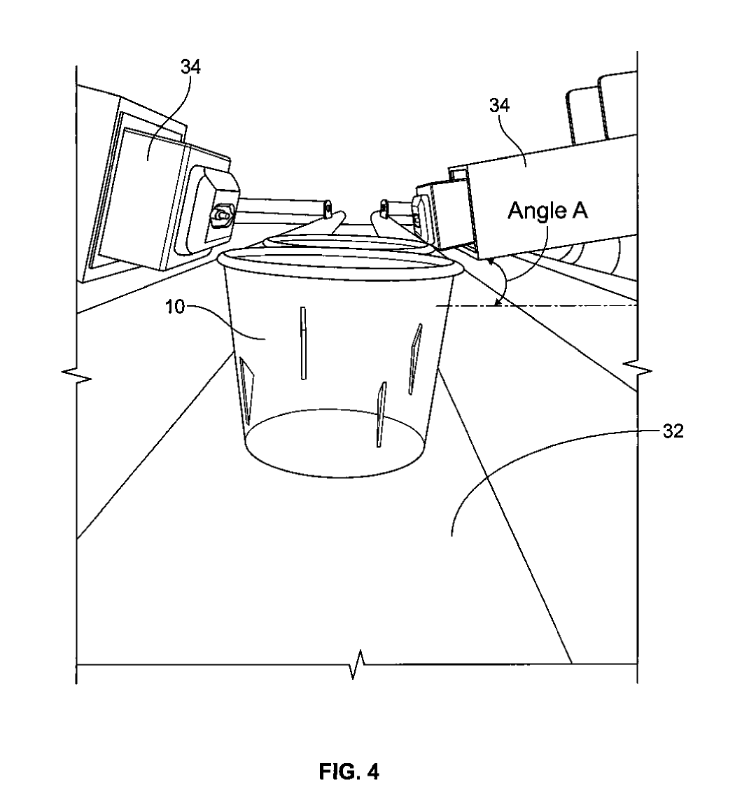

In an embodiment, the method of manufacturing the cup 10 includes the phase of sterilizing the cup 10. In an embodiment, the cup 10 is pre-sterilized before the phase of further sterilizing the cup 10. In an embodiment, step 200 includes placing one or more of the cups 10 on a conveyor belt 32 (see FIG. 4). In an embodiment, step 210 includes treating the cup 10 by ozone sterilization. In an embodiment, the step 210 includes using an ozone sterilization (i.e., ozone destruct) device 34. In another embodiment, the step 210 includes using a pair of ozone sterilization devices 34. In an embodiment, the ozone sterilization devices 34 are engaged and their high-frequency spot generators are turned on. In an embodiment, the conveyor 32 is turned on. In an embodiment, the conveyor 32 is turned on at a speed of 6 feet per second. In an embodiment, the cups 10 pass through the high-voltage discharges of the ozone sterilization devices 32. In an embodiment, the cups 10 pass through the high-voltage discharge of the devices 32 at an angle A (see FIG. 4). In an embodiment, the angle A is within a range of about 0.5 degree to about 45 degrees (see FIG. 4). In an embodiment, the discharge of each of the devices 32 covers about one-half of the circumference of the rim portion 24 of each cup 10. In an embodiment, step 220 includes storing the treated cups 10 in a sterilized container for further manufacturing thereof. In an embodiment, each container is labeled with the date of treatment.

In an embodiment, the method of manufacturing the cup 10 includes the phase of applying the flavored layer 28 and the crystal layer 30 to the rim portion 24 of the cup 10. In an embodiment, step 300 includes dipping the rim portion 24 of the cup 10 into the mixture of the liquid flavored layer 28. In an embodiment, any excess of the flavored layer 28 on the rim portion 24 is wiped off. In an embodiment, step 310 includes dipping the cup 10 with the flavored layer 28 thereon (which is either in liquid or semi-liquid form) into the sugar crystals to form the crystal layer 30. In an embodiment, the cup 10 is dipped into the sugar crystals for about 3 seconds. In another embodiment, the cup 10 is dipped into the sugar crystals for a time period in the range from about 1 second to about 5 seconds. In an embodiment, the cup 10 is gently tapped on the side to release any excess sugar crystals. In an embodiment, step 320 includes placing the cup 10 open-side up on a storage sheet.

In an embodiment, the method of manufacturing the cup 10 includes the phase of packaging the cups 10. In an embodiment, step 400 includes taking one coated cup 10 and gently stacking it on another coated cup 10, creating a stack of two cups 10. In an embodiment, the cups 10 may be stacked in trays or stacking support members, such as those disclosed in the Malkin Applications. In an embodiment, step 410 including placing the stacked cups 10 into a box insert. In an embodiment, steps 400 and 410 are repeated two more times to fill the insert. In an embodiment, the top of the insert is closed. In an embodiment, the box is gently tapped to ensure all loose sugar crystals fall out before shrink wrapping. In an embodiment, the covered insert is placed into a shrink wrap machine to seal the insert. In an embodiment, the sealed insert is place into appropriate packaging for shipping.

It should be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A method of manufacturing a dosage cup, comprising the steps of:
creating a flavored layer mixture;
sterilizing the dosage cup by at least one ozone sterilization device;
coating the rim of the dosage cup with the flavored layer mixture to form a flavored layer disposed thereon; and
coating the flavored layer with sugar crystals.

2. The method of claim 1, wherein the at least one ozone sterilization device emits a high-voltage charge to the rim of the cup at an angle in the range of about 0.5 degrees to about 45 degrees.

3. The method of claim 2, wherein the at least one ozone sterilization device includes a pair of ozone sterilization devices.

4. The method of claim 3, wherein one of the pair of ozone sterilization devices emits a high-voltage charge that covers one-half of the circumference of the rim of the cup, and the other of the pair of ozone sterilization devices emits a high-voltage charge that covers the other half of the circumference of the rim of the cup.

5. The method of claim 4, wherein the step of coating the rim of the dosage cup with the flavored layer mixture includes dipping the rim of the dosage cup into the flavored layer mixture.

6. The method of claim 5, wherein the step of coating the flavored layer disposed on the rim of the dosage cup with sugar crystals includes dipping the rim of the dosage cup into the sugar crystals.

7. The method of claim 6, further comprising the step of placing the cup on a conveyor to facilitate the movement of the cup through the high-voltage discharges of the ozone sterilization devices.

8. The method of claim 7, wherein the flavored layer mixture includes sucrose and at least one natural flavor.

9. The method of claim 8, further comprising the step of stacking the coated cups within a box insert.

10. The method of claim 1, wherein the cup is adapted to measure liquid pediatric medicine.
